(19) United States
(12) Patent Application Publication
(10) Pub. No.: US 2015/0113388 A1
(43) Pub. Date: Apr. 23, 2015

(54) METHOD AND APPARATUS FOR PERFORMING TOPIC-RELEVANCE HIGHLIGHTING OF ELECTRONIC TEXT

(71) Applicant: QUALCOMM Incorporated, San Diego, CA (US)

(72) Inventors: David A. Barrett, San Diego, CA (US); David Wayne Hanson, San Diego, CA (US)

(73) Assignee: QUALCOMM Incorporated, San Diego, CA (US)

(21) Appl. No.: 14/060,501

(22) Filed: Oct. 22, 2013

(51) Int. Cl. G06F 17/21; G06F 17/30

(52) U.S. Cl. CPC G06F 17/211; G06F 17/3053
USPC 715/249

(57) ABSTRACT

Topic-relevance highlighting of electronic text is described that includes categorizing words in the electronic text into several classes, determining the relevance weight for each word based on their relevance to one or more classes, and then color-coding words according to their classes. Each class represents a specific topic of interest and is assigned a distinctive color. Words or phrases in the electronic text belonging to the same class would be highlighted with the same distinctive color. Accordingly, users can instantly identify whether the document is relevant, to which topic of interest the document is relevant, and the relevant portions of the document page which match users' interests.

### BACKGROUND

1. Field

The present disclosure relates, in general, to the field of document presentation system, and more particularly to methods and apparatus for performing topic-relevance highlighting of electronic text.

2. Background

The ability to store documents electronically has led to an information explosion and the volume of electronic information is still continuously increasing at a very high rate. Therefore, the average amount of time and resources for readers to understand electronic text in each document is shrinking. These changes motivate development of document presentation systems.

Some applications have applied data visualization techniques to document presentation system design in order to help readers to identify relevant documents or capture the idea of text in a short time. Data visualization is the study of visual representation of data and has become an active area of research, teaching and development in the 21^{th} century. Its main goal is to communicate information clearly and effectively and may include subjects of mindmaps and displaying news, data, connections, websites, article, and resources. From a computer science perspective, data visualization may be categorized into a number of sub-fields, including visualization algorithms and techniques, volume visualization, information visualization, multi-resolution methods, modeling techniques, and interaction techniques and architectures.

For example, in a traditional text search system, such as Google, search terms occurring in the retrieved documents are highlighted to give the user feedback. For another example, some existing prior art utilizes a visual representation indicating the topic within a text in order for readers to extract salient information from the text.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The various aspects of the present teachings are directed to a method, corresponding apparatus, and program codes for performing topic-relevance highlighting of electronic text in a document. The user determines degree of relevance of a document based on the highlighted electronic text contained therein. As such, the user would be able to rapidly pick out the relevant documents from a mass of documents without even reading their content. Further, the user can efficiently read documents by instantly identifying the relevant portions of the document page which match the user's interests.

In one aspect of the disclosure, a method for performing topic-relevance highlighting of electronic text in a document is disclosed. The method includes categorizing a plurality of words in the electronic text into one or more classes, determining one or more relevance weights for the plurality of words based on their relevance to the one or more classes, and color-coding the plurality of words according to their one or more relevance weights such that one or more words of the plurality of words categorized into the same class with the same topic of interest are highlighted with the same distinctive color. Each class represents a topic of interest,

In an additional aspect of the disclosure, an apparatus for performing topic-relevance highlighting of electronic text in a document is configured. The apparatus includes means for categorizing a plurality of words in the electronic text into one or more classes, means for determining one or more relevance weights for the plurality of words based on their relevance to the one or more classes, and means for color-coding the plurality of words according to their one or more relevance weights such that one or more words of the plurality of words categorized into the same class with the same topic of interest are highlighted with the same distinctive color.

In an additional aspect of the disclosure, a computer program product comprising a computer-readable medium having program code recorded thereon is disclosed. This program code includes code for causing a computer to categorize a plurality of words in the electronic text into one or more classes, determine one or more relevance weights for the plurality of words based on their relevance to the one or more classes, and color-code the plurality of words according to their one or more relevance weights such that one or more words of the plurality of words categorized into the same class with the same topic of interest are highlighted with the same distinctive color.

In an additional aspect of the disclosure, an apparatus including at least one processor and a memory coupled to the processor is configured. The processor is configured to categorize a plurality of words in the electronic text into one or more classes, determine one or more relevance weights for the plurality of words based on their relevance to the one or more classes, and color-code the plurality of words according to their one or more relevance weights such that one or more words of the plurality of words categorized into the same class with the same topic of interest are highlighted with the same distinctive color.

### BRIEF DESCRIPTION OF THE DRAWINGS

FIGS. 1A and 1B are examples of highlighted documents according to various aspects of the present disclosure.

FIGS. 2A and 2B are examples of highlighted documents according to various aspects of the present disclosure.

FIG. 3 is an example of a highlighted document according to one aspect of the present disclosure.

FIG. 4 is an example of a legend according to one aspect of the present disclosure.

FIG. 5 illustrates examples of word lists stored in a database according to various aspects of the present disclosure.

FIGS. 6A and 6B are examples ranking charts according to various aspects of the present disclosure.

FIG. 7 is a functional block diagram illustrating example blocks executed to implement one aspect of the present disclosure.

FIG. 8 is a functional block diagram illustrating example blocks executed to implement one aspect of the present disclosure.

FIG. 9 is a functional block diagram illustrating example blocks executed to implement one aspect of the present disclosure.

FIG. 10 is a block diagram illustrating an apparatus for performing topic-relevance highlighting of electronic text in accordance with an exemplary aspect of the present disclosure.

### DETAILED DESCRIPTION

A need exists for a document presentation system incorporating data visualization concepts that could help readers to instantly determine the degree of relevance of the document and efficiently analyze documents. The present application provides a method and corresponding apparatus for performing topic-relevance highlighting of electronic text in a document, including categorizing words in the electronic text into several classes, determining the relevance weight for each word based on their relevance to one or more classes, and then color-coding words according to their classes. It could help users to instantly identify whether the document is relevant, to which topic of interest the document is relevant, and the relevant portions of the document page which match users' interests. Accordingly, users would be able to rapidly pick out the relevant documents from a mass of documents without even reading their content.

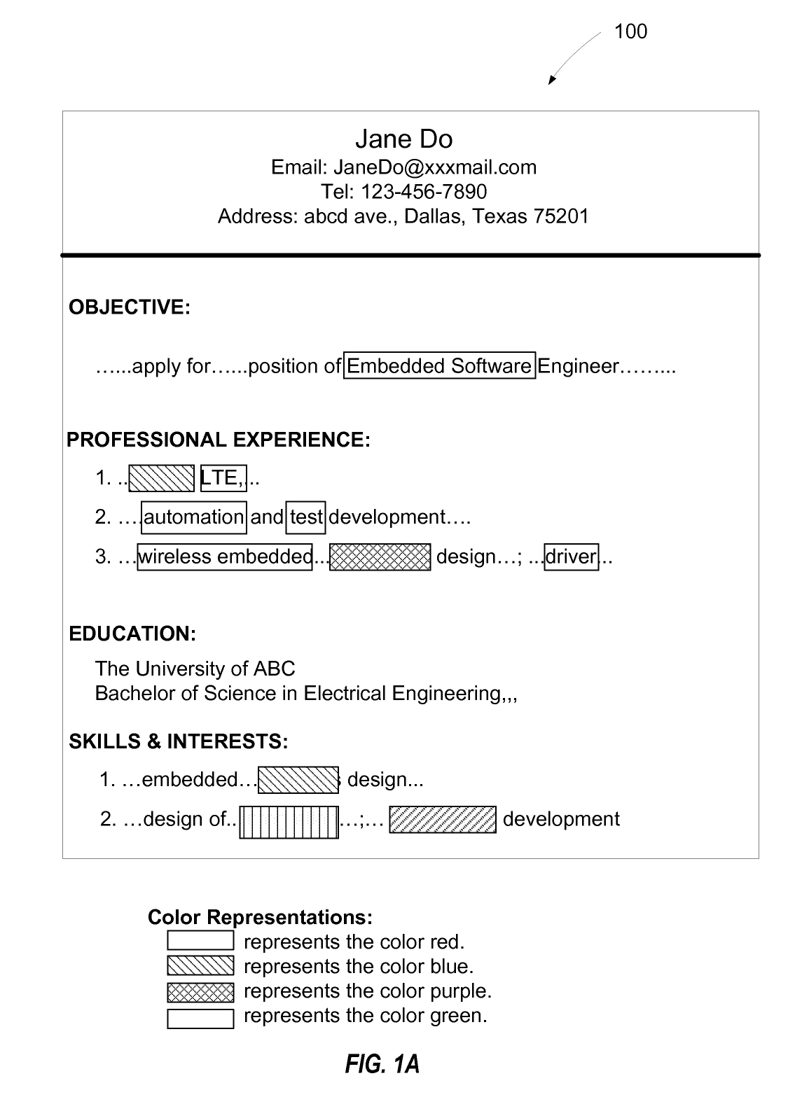

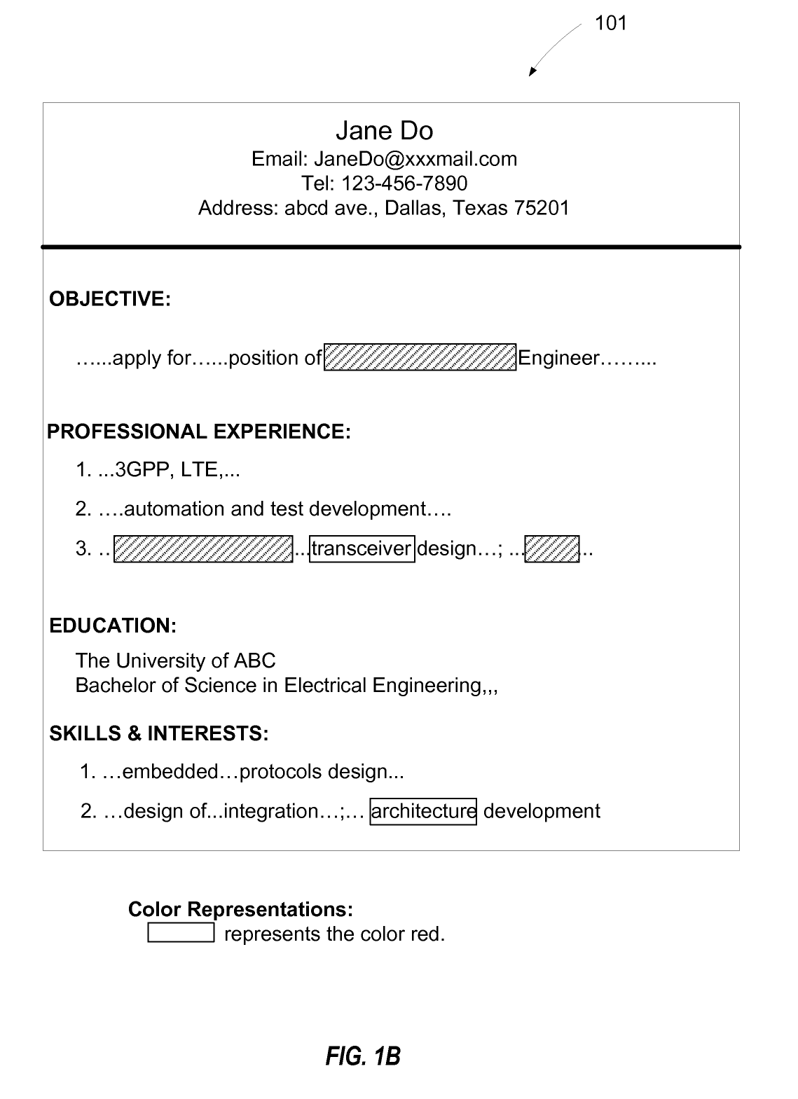

FIG. 1A is an example of a highlighted document according to one aspect of the present disclosure. Highlighted resume 100 shows four highlighted classes of words. Each word is determined one or more relevance weights based on its relevance to one or more classes. Each class represents a topic of interest. Words which belong to the same class are highlighted with the same distinctive color. For example, the words “embedded software,” “driver,” and “architecture” are all related to embedded technology and highlighted in red. The words “3GPP,” “LTE,” and “protocols” are all related to wireless communication technology and highlighted in blue. The words “automation,” “test,” and “integration” are all related to testing technology and highlighted in green. Also, a word may belong to multiple classes and be highlighted with a mixture of colors. For example, the words “wireless embedded” and “transceiver” are related to both embedded technology (red) and wireless communication technology (blue), and, therefore, it can also be categorized into a third class named wireless embedded technology and highlighted in purple, which is a mixture of red and blue. Accordingly, a user, such as a HR staff, would be able to instantly tell the expertise of the job applicant to facilitate recruitment. For example, highlighted resume 100 may show that Ms. Jane Do is more suitable for embedded or wireless communication engineer positions rather than a testing engineer position.

In one aspect of the present disclosure, a distinctive indicator is associated to each class and applied to electronic text. The distinctive indicator may indicate a distinctive color, a distinctive font style, a distinctive effect, or any distinctive characteristic of the class. For example, a distinctive indicator may be associated to the class representing testing technology and indicate a green color, as shown in FIG. 1A. For another example, the distinctive indicator may be associated to the class representing testing technology and indicate a distinctive font style (bold), instead of a distinctive color (green). Also, such distinctive indicator may indicate a distinctive effect, including, but not limited to, changing the background color of the word. The reader could freely choose the way to highlight words. The reader could also freely choose the same or different ways to highlight multiple classes of words.

In one aspect of the present disclosure, a threshold is determined for the relevance weight by the user or by the system algorithm. Accordingly, one or more words are not highlighted if its or their weights are below the threshold. Also, a threshold may be determined for the total relevance weight for each class. Accordingly, all the words in the same class are not highlighted if the total relevance weight for such class is below the threshold.

FIG. 1B is an example of a highlighted document according to one aspect of the present disclosure. Highlighted resume 101 shows merely one highlighted class of words. The words “embedded software,” “wireless embedded,” “transceiver,” “driver,” and “architecture” are all related to embedded technology and highlighted in red. As stated above, the words “wireless embedded” and “transceiver” are actually related to three topics of interests, including embedded technology associated with red, wireless communication technology associated with blue, and wireless embedded technology associated with purple. They could be highlighted in purple, which is a mixture of red and blue, as shown in FIG. 1A. The could also be highlighted with one of the three associated colors, as shown in FIG. 1B. Users could freely choose the topics of interests for which the words are highlighted based on their needs. For example, the topic of interest for a HR staff may be a job position. If the HR staff merely searches for candidates for an embedded engineer position, he/she may only want one color to be displayed in the resume, as shown in FIG. 1B. However, if the HR staff searches for candidates for embedded engineer, wireless communication engineer, and wireless embedded engineer positions at the same time, he/she may require multiple colors to be displayed in the resume, as shown in FIG. 1A.

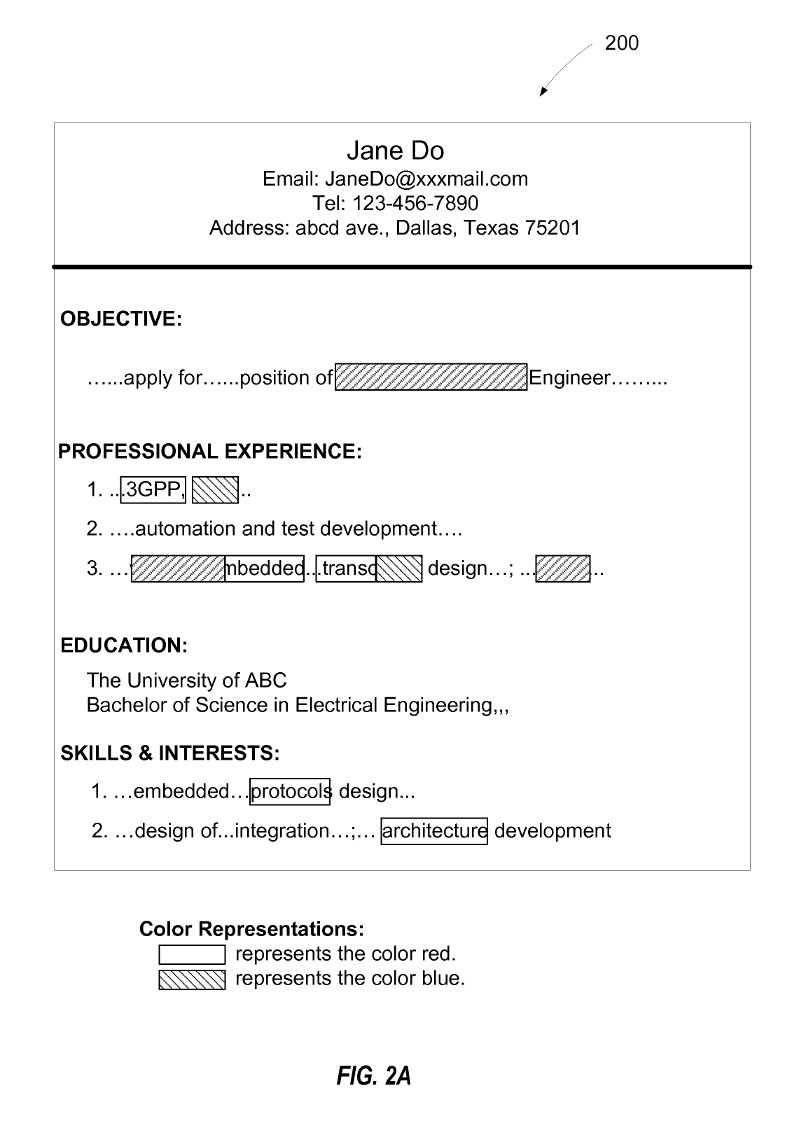

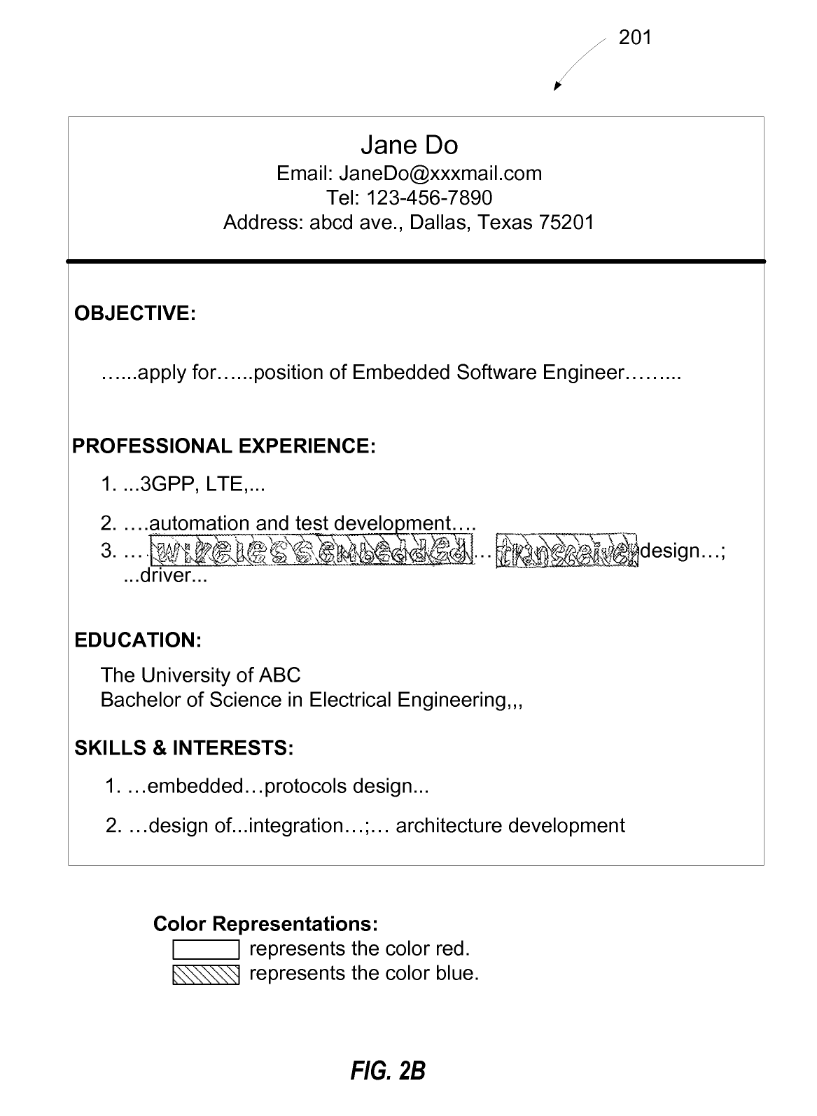

FIGS. 2A and 2B are examples of highlighted documents according to various aspects of the present disclosure. The words “wireless embedded” and “transceiver” contained in highlighted resume 200 and 201 are highlighted with multiple colors rather than a mixture of colors, as shown in FIG. 1A. In FIG. 2A, the words “wireless embedded” and “transceiver” are highlighted with separate color blocks. In FIG. 2B, the words “wireless embedded” and “transceiver” are highlighted in red on a blue background. Accordingly, the user could immediately tell all topics of interests the words are associated. It should be noted that the various aspects of the present disclosure are not limited to a specific number of colors to highlight one word or phrase.

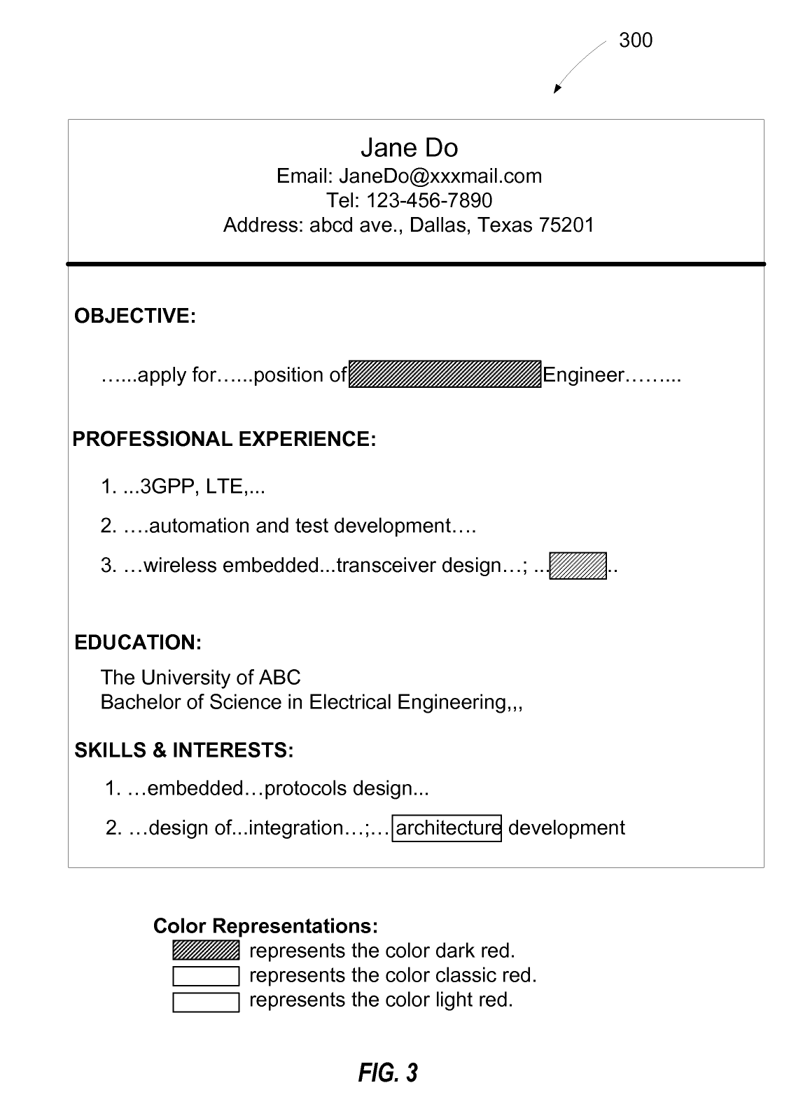

FIG. 3 is an example of a highlighted document according to one aspect of the present disclosure. Highlighted resume 300 shows one highlighted class of words. The words “embedded software,” “driver,” and “architecture” are all highlighted in red but with different color saturation. The saturation of color relates to the relevance weigh which is determined based on the relevance of word to the class. The word “embedded software” is highlighted in dark red and the word “architecture” is highlighted in light red. It means that the word “embedded software” is more associated with embedded technology than the word “architecture” is. Accordingly, users could immediately determine degree of relevance of the document based on color saturation. For example, if a HR staff wants to recruit a senior embedded engineer, he/she could pay more attention to resumes with more words highlighted in dark red.

In some aspects of the present disclosure, contents of multiple highlighted resumes may be summarized in an excel file. Each cell of the excel file may contain one or multiple bullet points of one resume. Bullet points may include keywords in the resume, especially words regarding job applicants' expertise. Bullet points may also include applicants' names and which positions they are applying for. Relevant words are still highlighted in colors according to their relevance weights and classes. Accordingly, the HR staff could browse all candidates' information within one file.

It should be noted that the various aspects of the present disclosure are not limited to a specific number of keywords and classes, a specific color, or a specific type or format of document. Document may be a Adobe Systems, Inc., PDF file, a Microsoft Corporation EXCEL™ file, a Microsoft Corporation WORD™ file, a Joint Photographic Experts Group (jpg) file, or any electronic file. Document may be a resume, a patent document, an academic journal, a technical document, or any electronic document. Therefore, patent attorneys, engineers, researchers, or people who need to read and analyze large amount of documents could also be benefited from the present disclosure. Furthermore, if the text is long, the present disclosure could also help the user to instantly identify which portion of the document page is relevant.

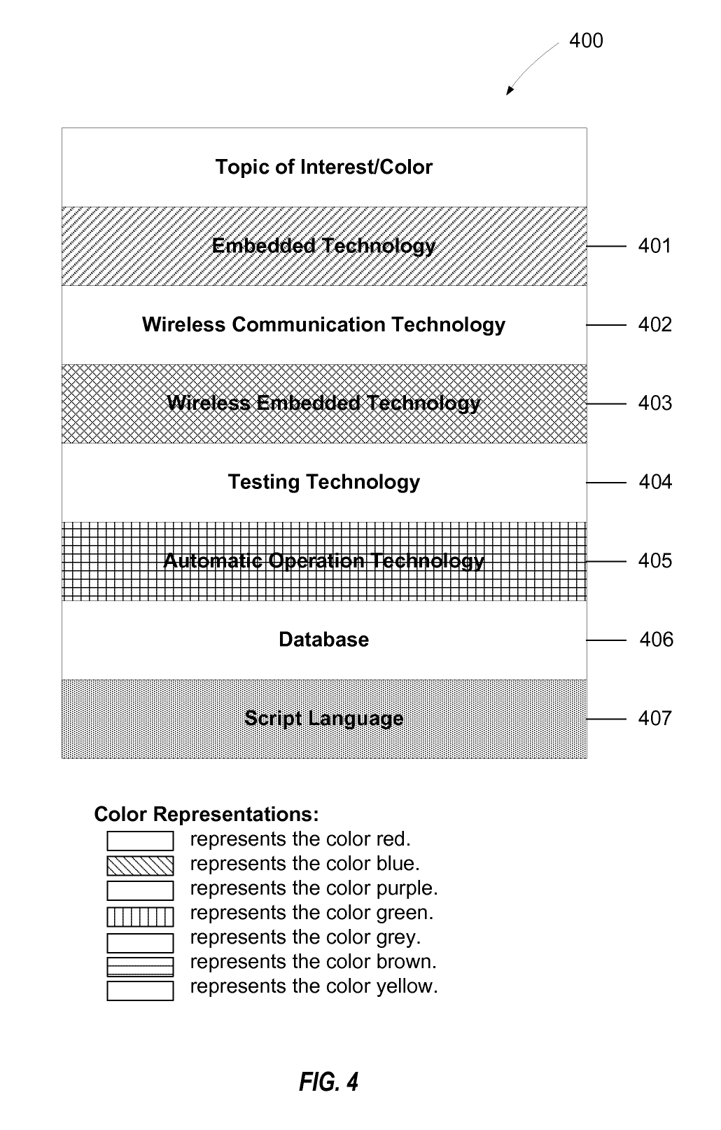

FIG. 4 is an example of a legend according to one aspect of the present disclosure. Each of blocks 401, 402, 403, 404, 405, 406, and 407 in legend 400 provide information regarding an association between a distinctive color and a topic of interest. The design of legend 400 utilizes visualization techniques in order for readers to capture contained information immediately. Legend 400 may be pre-built manually by the user or automatically by the system. Legend 400 may be shown on the screen or printed out as a note while the user is reading and analyzing documents. Legend 400 may be editable manually or automatically anytime based on users' needs. It should be noted that the design of legend is not limited a specific color, style, or format.

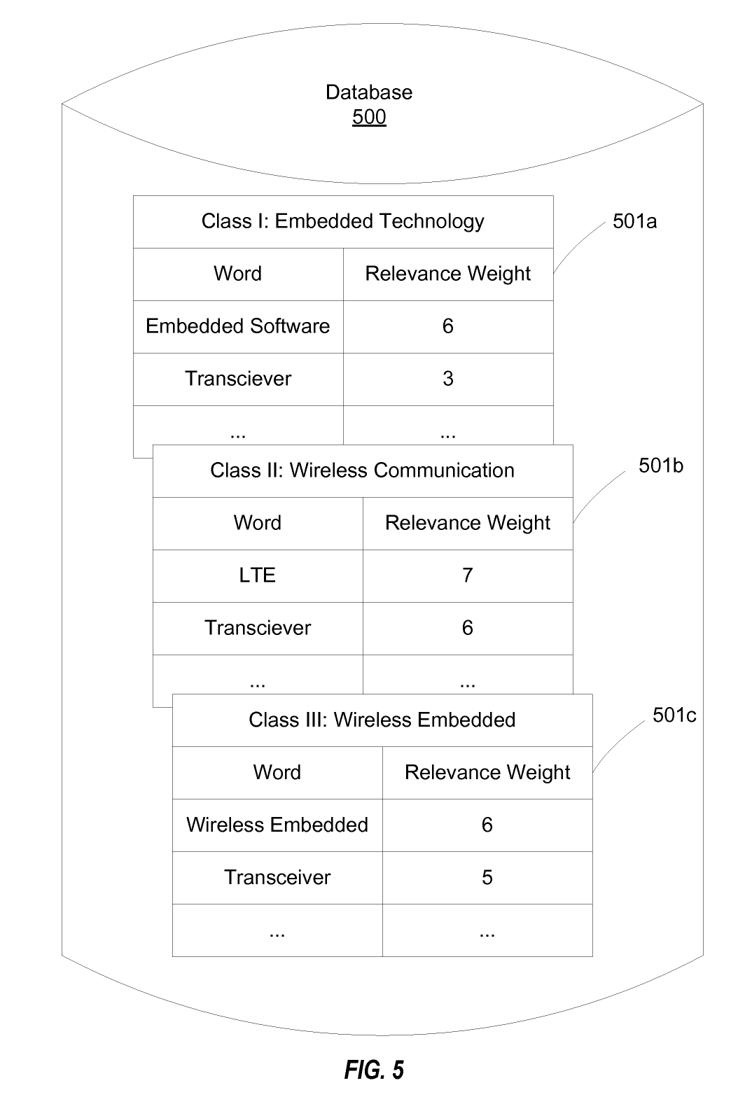

FIG. 5 illustrates examples of word lists stored in a database according to one aspect of the present disclosure. Each class representing a specific topic of interest has its own word list, which contains words or phrases associated with the class and their relevance weights. For example, each of word lists 501a, 501b, and 501c stored in database 500 includes words related to the embedded technology, wireless communication technology, and wireless embedded technology, respectively. In some aspects of the present disclosure, a word may be listed on multiple word lists. For example, the word “transceiver” is related to three topics of interests, and, therefore, it is listed on all word lists 501a, 501b, and 501c. However, its corresponding relevance weight for each class may be different. In some aspects of the present disclosure, the words or phrases of each of the classes may overlap.

In some aspects of the present disclosure, the relevance weight of the word may be a negative value for some classes when such word is irrelevant to these classes. For example, a word “hardware” may have a negative relevance weight for the class of software technology. This function may help the user to instantly detect irrelevant documents with irrelevant words or phrases in order to efficiently filter out irrelevant documents.

Information regarding classes of words and relevance weights of words in database 500 may be manually pre-built by the user or automatically pre-built by a machine learning classification algorithm and reference text data. For example, the relevance weights may be generated by a set of binary classifiers from linear Support Vector Machines (“SVM”). In machine learning, SVM are supervised learning models with associated learning algorithms that analyze data and recognize patterns. Each binary classifier assigns a numeric weight to each word based upon the relevance of word to its classification. The fixed weights, as references, may be established by using a “training set” of example documents, which are labeled as either relevant, or not relevant. For another example, a topic probability score assigned to the word by a topic modeling system may be in place of the numeric weight assigned by the binary classifier. In some aspects of the present disclosure, the machine learning classification algorithm may select words from electronic text to be categorized or highlighted before assigning relevance weight to every word in the electronic text in order to save system resources. It should be noted that the various aspects of the present disclosure are not limited to a specific number of word lists, a specific number of words contained in the word lists, and a specific method to determine relevance weights.

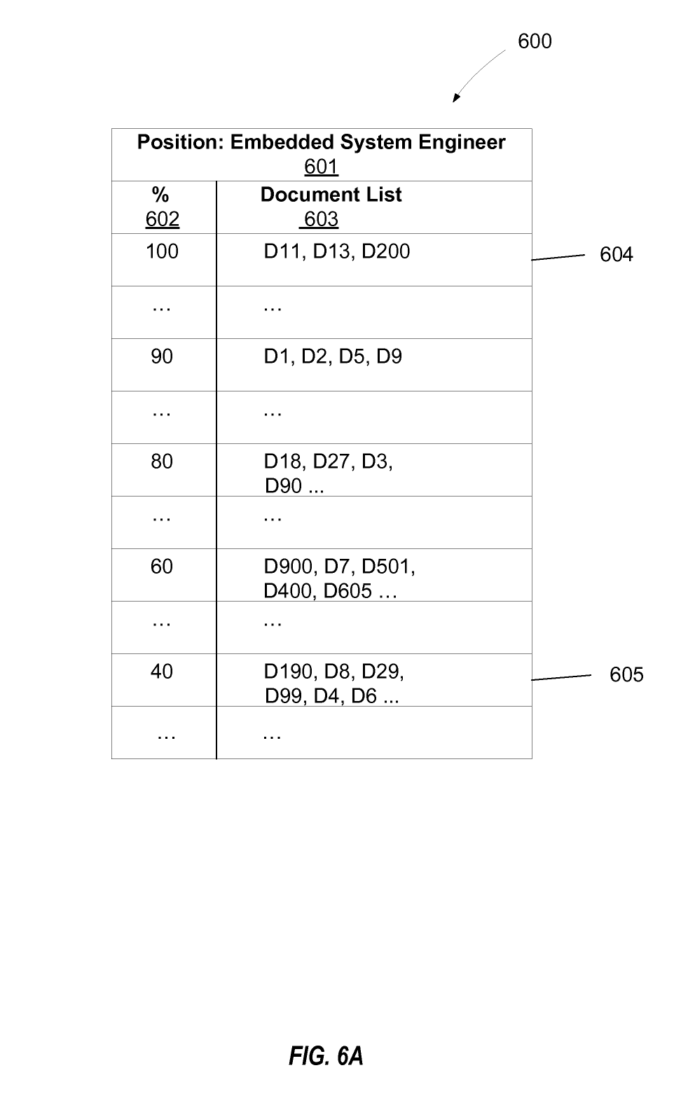

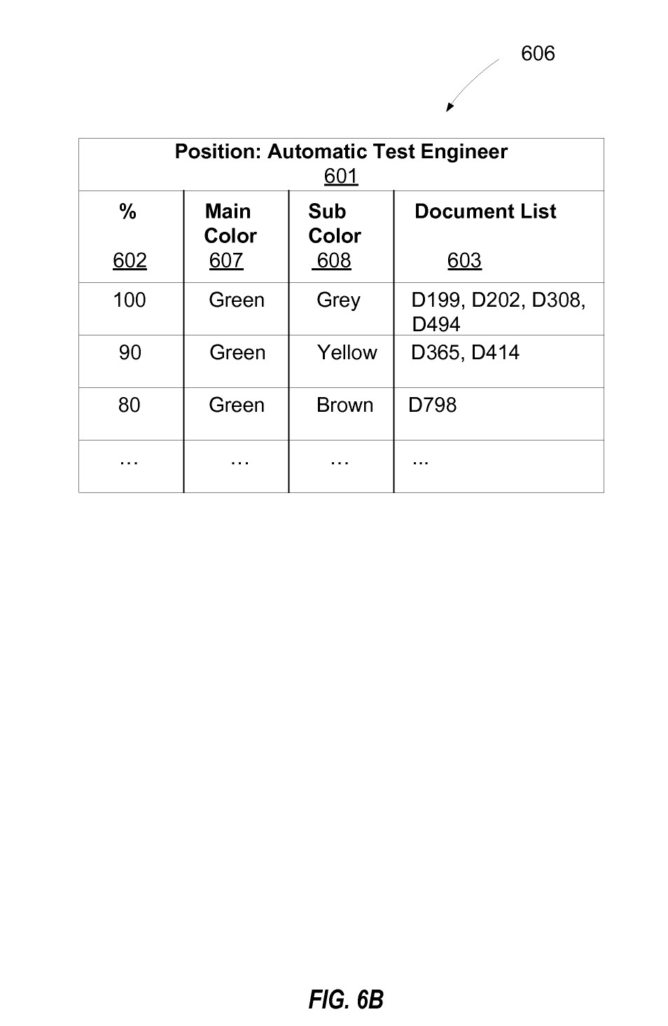

FIG. 6A is an example of a ranking chart according to one aspect of the present disclosure. Ranking chart 600 includes topic of interest column 601, relevance rating column 602, and document list column 603 and ranks all documents associated with the same topic of interest according to their relevance weights. The relevance degree of each document to each class may be determined by the sum of relevance weights of words belonging to that class or other weighting methods. Ranking chart 600 provided in FIG. 6A is an exemplary ranking chart used by a HR staff. An embedded system engineer position is the topic of interest of the HR staff. Each of resumes received for this position are assigned a document number, such as D200 in block 604, and ranked based on its relevance degree to this position. D200 in block 604 is ranked higher than D190 listed in block 605 and so the owner of D200 may have better chance to be picked by an interviewer. In some aspects of the present disclosure, ranking chart 600 may be directly linked to the documents for user's convenience. For example, the HR staff may open the resume no. 200 by clicking “D200” in block 604 directly.

FIG. 6B is an example of a ranking chart according to one aspect of the present disclosure. Ranking chart 606 have two additional columns: main color column 607 and sub color column 608. The main color may be the highest occurring color (most predominant color) or the color associated with the class having the highest total relevance weight in each document. The sub color may be the second highest occurring color or the color associated with the class having the second highest total relevance weight in each document. The user could freely choose either way to determine the color to be listed in the main color column 607 and sub color column 608. The relevance degree of each document to each class of interest may be determined by the (possibly weighted) sum of relevance weights of words belonging to such class of interest. Accordingly, users could instantly pick documents according to their preferred combination of topics of interests or preferred combination of topics of interests and topics of non-interests. For example, if the HR staff searches for candidates for an automatic test engineer position, he/she could pick the resumes having green as the main color and yellow as the sub color in order to get information of candidates with double background of testing technology and script language. For another example, if the HR staff searches for candidates with pure hardware background for a testing engineer position, he/she could pick the resumes with green as the main color and without brown and yellow as the sub color. It should be noted that the various aspects of the present disclosure are not limited to a specific number of colors identified on a ranking chart or specific information listed on a ranking chart. For example, the topic of interest column 601 may list an interested technology field, instead of a job position when the user processes patent documents, instead of resumes.

In some aspects of the present disclosure, the relevance degree of each document to each class of interest may be determined by a combination of relevance weights of words belonging to such class of interest and relevance weights of words belonging to other classes which such document is also categorized into. For example, the documents listed in FIG. 6B may also be ranked according to their relevance weights of words belonging to the class associated with the main color and their relevance weights of words belonging to the class associated with the sub color. There may be multiple ways to calculate the results of the combination of relevance weights of words of the class of interest and relevance weights of words belonging to other classes into which the document is also categorized to determine the final relevance degree. For example, the final relevance weight can be the average of the relevance weights of the class of interest and all other classes which the document is also categorized into.

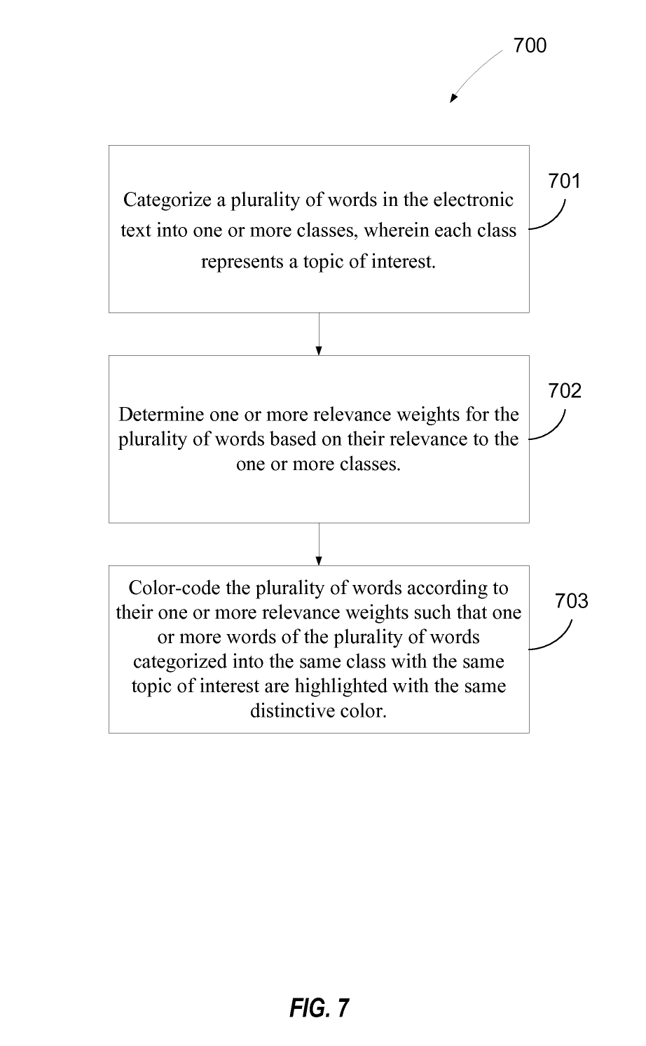

FIG. 7 is a functional block diagram illustrating example blocks executed to implement one aspect of the present disclosure. The method 700 for performing topic-relevance highlighting of electronic text may be implemented on various devices including, but not limited to, a computer, a tablet computer, a mobile computer, or any electronic device which is able to display electronic text. In block 701, a plurality of words in the electronic text are categorized into one or more classes. Each class represents a topic of interest. In block 702, one or more relevance weights for the plurality of words are determined based on their relevance to the one or more classes. In block 703, the plurality of words are color-coded according to their one or more relevance weights such that one or more words of the plurality of words categorized into the same class with the same topic of interest are highlighted with the same distinctive color. In some aspects of the present disclosure, a linear SVM may categorize the plurality of words and determine the corresponding relevance weights together. For example, the linear SVM may utilize a unified algorithm to categorize the plurality of words and determine the corresponding relevance weights.

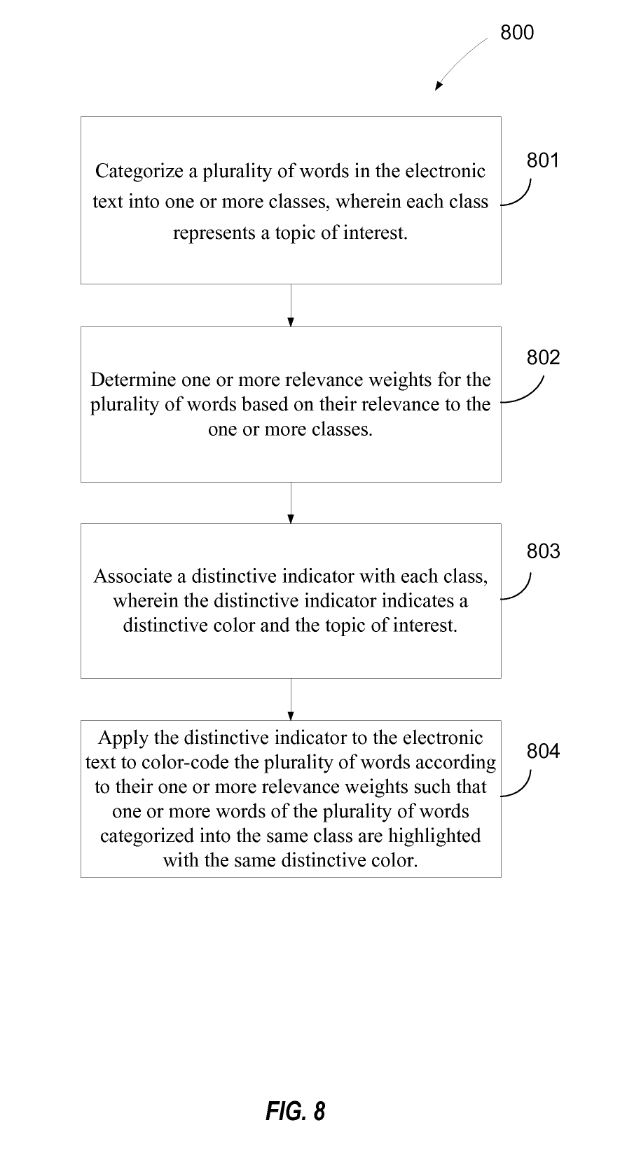

FIG. 8 is a functional block diagram illustrating example blocks executed to implement one aspect of the present disclosure. The method 800 for performing topic-relevance highlighting of electronic text may be implemented on various devices including, but not limited to, a computer, a tablet computer, a mobile computer, or any electronic device which is able to display electronic text. In block 801, a plurality of words in the electronic text are categorized into one or more classes. Each class represents a topic of interest. In block 802, one or more relevance weights for the plurality of words are determined based on their relevance to the one or more classes. In block 803, a distinctive indicator is associated with each class. The distinctive indicator indicates a distinctive color and the topic of interest. In block 804, the distinctive indicator is applied to the electronic text to color-code the plurality of words according to their one or more relevance weights such that one or more words of the plurality of words categorized into the same class are highlighted with the same distinctive color.

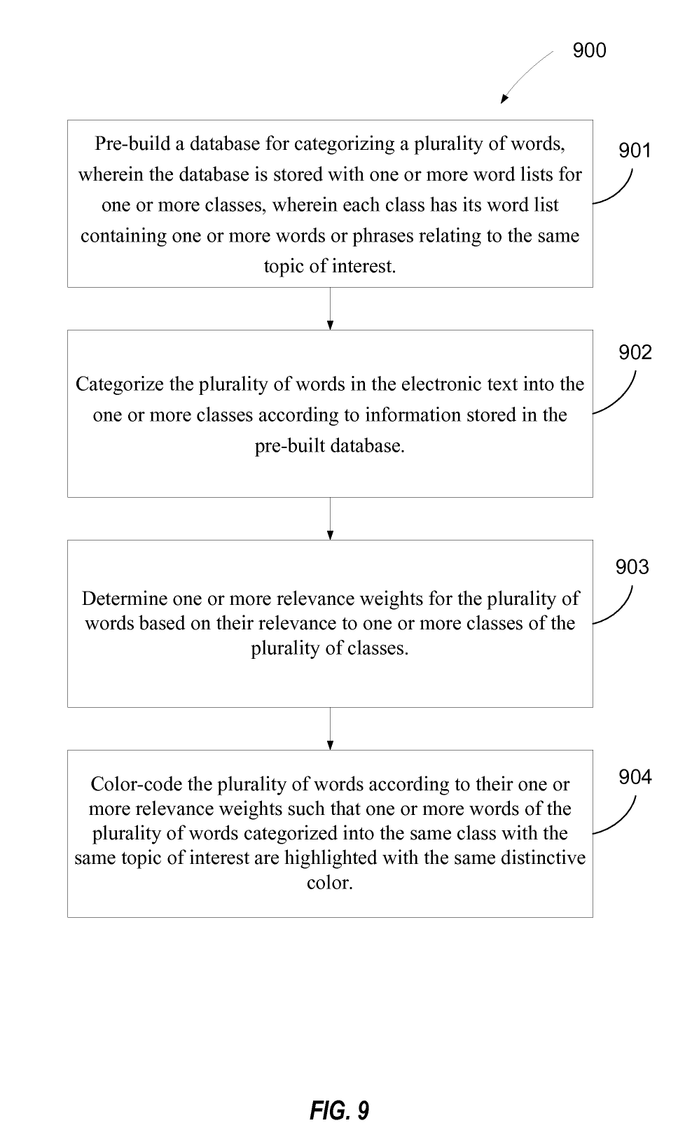

FIG. 9 is a functional block diagram illustrating example blocks executed to implement one aspect of the present disclosure. The method 900 for performing topic-relevance highlighting of electronic text may be implemented on various devices including, but not limited to, a computer, a tablet computer, a mobile computer, or any electronic device which is able to display electronic text. In block 901, a database for categorizing a plurality of words is pre-built. The database is stored with one or more word lists for one or more classes. Each class has its word list containing one or more words or phrases relating to the same topic of interest. In block 902, a plurality of words in the electronic text are categorized into one or more classes. Each class represents a topic of interest. In block 903, one or more relevance weights for the plurality of words are determined based on their relevance to the one or more classes. In block 904, the plurality of words are color-coded according to their one or more relevance weights such that one or more words of the plurality of words categorized into the same class with the same topic of interest are highlighted with the same distinctive color.

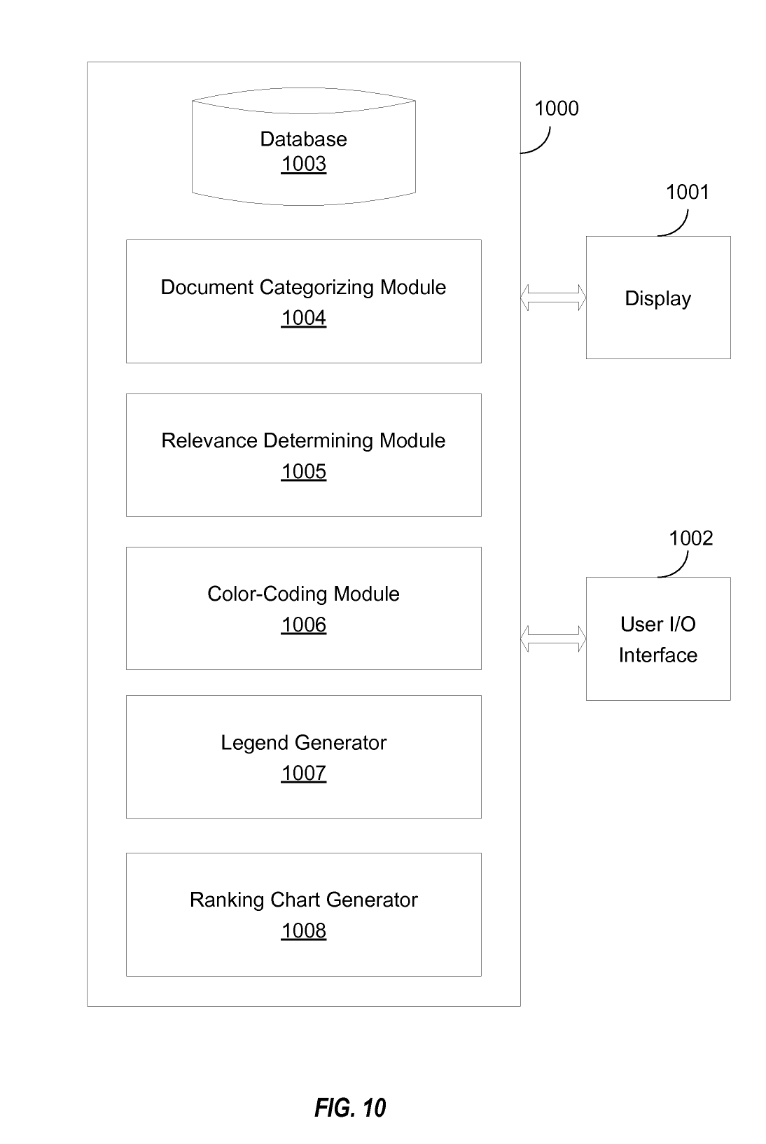

FIG. 10 is a block diagram illustrating an apparatus for performing topic-relevance highlighting of electronic text in accordance with an exemplary aspect of the present disclosure. Apparatus 1000 includes database 1003, document categorizing module 1004, relevance determining module 1005, color coding module 1006, legend generator 1007, and ranking chart generator 1008. Database 1003 is configured to store information regarding classes of words and their corresponding relevance weights. Document categorizing module 1004 is configured to categorize a plurality of words in the electronic text into one or more classes. Relevance determining module 1005 is configured to determine one or more relevance weights for the plurality of words based on their relevance to the one or more classes. Color coding module 1006 is configured to color-code the plurality of words according to their one or more relevance weights such that one or more words of the plurality of words categorized into the same class with the same topic of interests are highlighted with the same distinctive color. Legend generator 1007 is configured to generate a legend to provide information regarding an associate between a distinctive color and a topic of interest. Ranking chart generator 1008 is configured to compile a ranking chart to rank the one or more documents according to their class information or relevance weight information of the plurality of words.

In some aspects of the present disclosure, apparatus 1000 may further include a module to select a plurality of words from electronic text before relevance determining module 1005 assigns relevance weight to all words. In other aspects of the present disclosure, apparatus 1000 may be connected with display 1001 and User I/O interface 1002 to communicate with users. Highlighted electronic text is shown on display 1001 and documents are picked by the user via User I/O interface 1002. The user may also edit information stored in database 1003, the legend generated by legend generator 1007, the ranking chart compiled by ranking chart generator 1008, or any other parameters of apparatus 1000 via User I/O interface 1002.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules in FIGS. 7-9 may comprise processors, electronics devices, hardware devices, electronics components, logical circuits, memories, software codes, firmware codes, etc., or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for performing topic-relevance highlighting of electronic text in one or more documents, comprising:
categorizing a plurality of words in the electronic text into one or more classes, wherein each class represents a topic of interest;
determining one or more relevance weights for the plurality of words based on their relevance to the one or more classes; and
color-coding the plurality of words according to their one or more relevance weights such that one or more words of the plurality of words categorized into the same class with the same topic of interest are highlighted with the same distinctive color.

2. The method of claim 1, wherein the color-coding the plurality of words comprises associating a distinctive indicator with each class and applying one or more distinctive indicators to the electronic text, wherein the distinctive indicator indicates the distinctive color and the topic of interest.

3. The method of claim 2, wherein the distinctive indicator further indicates a distinctive font style or effect such that the one or more words of the plurality of words categorized into the same class with the same topic of interest are highlighted with the same distinctive font style or effect.

4. The method of claim 1, further comprising:
determining a relevancy threshold for the color-coding, wherein one or more words of the plurality of words are not highlighted when the one or more relevance weights determined for the one or more words fails to exceed the threshold.

5. The method of claim 1, further comprising:
building a legend to provide information regarding an association between the distinctive color and the topic of interest.

6. The method of claim 1, further comprising:
pre-building a database for the categorizing the plurality of words, wherein the database is stored with one or more word lists for the one or more classes, wherein each class has its word list containing one or more words or phrases relating to the same topic of interest.

7. The method of claim 6, wherein the database includes information regarding the one or more relevance weights of the plurality of words based on their relevance to the one or more classes.

8. The method of claim 6, wherein the database is manually pre-built or automatically pre-built by a machine learning classification algorithm and reference text data.

9. The method of claim 1, further comprising:
compiling a ranking chart to rank the one or more documents according to its or their class information or relevance weight information of the plurality of words.

10. The method of claim 9, wherein the ranking chart is linked to the one or more documents.

11. The method of claim 1, further comprising:
displaying the electronic text highlighted with the one or more distinctive colors.

12. The method of claim 11, wherein the displaying the electronic text comprises determining the number of colors to be displayed.

13. The method of claim 1, wherein saturation of the distinctive color relates to the relevance weight.

14. The method of claim 1, wherein the one or more words of the plurality of words are highlighted with multiple colors.

15. The method of claim 14, wherein the multiple colors are displayed in separate color blocks.

16. The method of claim 14, wherein the multiple colors are mixed with each other to produce a final color to be displayed.

17. The method of claim 1, wherein the one or more documents are one or more of:
a resume;
a patent document;
an academic journal; and
a technical document.

18. An apparatus for performing topic-relevance highlighting of electronic text in one or more documents, comprising:
means for categorizing a plurality of words in the electronic text into one or more classes, wherein each class represents a topic of interest;
means for determining one or more relevance weights for the plurality of words based on their relevance to the one or more classes; and
means for color-coding the plurality of words according to their one or more relevance weights such that one or more words of the plurality of words categorized into the same class with the same topic of interest are highlighted with the same distinctive color.

19. The apparatus of claim 18, wherein the means for color-coding the plurality of words comprises:
means for associating a distinctive indicator with each class and applying one or more distinctive indicators to the electronic text, wherein the distinctive indicator indicates the distinctive color and the topic of interest.

20. The apparatus of claim 18, further comprising:
means for building a legend to provide information regarding an association between the distinctive color and the topic of interest.

21. The apparatus of claim 18, further comprising:
means for pre-building a database for the categorizing the plurality of words, wherein the database is stored with one or more word lists for the one or more classes, wherein each class has its word list containing one or more words or phrases relating to the same topic of interest.

22. The apparatus of claim 18, further comprising:
means for compiling a ranking chart to rank the one or more documents according to its or their class information or relevance weight information of the plurality of words.

23. The apparatus of claim 18, further comprising:
means for displaying the electronic text highlighted with the one or more distinctive colors.

24. The apparatus of claim 18, further comprising:
means for selecting the one or more documents according to results of color highlighting.

25. A computer program product for performing topic-relevance highlighting of electronic text in one or more documents, comprising:
a non-transitory computer-readable medium having program code recorded thereon, the program code including:
program code for causing a computer to:
categorize a plurality of words in the electronic text into one or more classes, wherein each class represents a topic of interest;
determine one or more relevance weights for the plurality of words based on their relevance to the one or more classes; and
color-code the plurality of words according to their one or more relevance weights such that one or more words of the plurality of words categorized into the same class with the same topic of interest are highlighted with the same distinctive color.

26. The computer program product of claim 25, wherein the program code to color-code the plurality of words comprises program code to associate a distinctive indicator with each class and applying one or more distinctive indicators to the electronic text, wherein the distinctive indicator indicates the distinctive color and the topic of interest.

27. The computer program product of claim 25, further comprising:
program code for causing a computer to build a legend to provide information regarding an association between the distinctive color and the topic of interest.

28. The computer program product of claim 25, further comprising:
program code for causing a computer to pre-build a database for the categorizing the plurality of words, wherein the database is stored with one or more word lists for the one or more classes, wherein each class has its word list containing one or more words or phrases relating to the same topic of interest.

29. The computer program product of claim 25, further comprising:
program code for causing a computer to compile a ranking chart to rank the one or more documents according to its or their class information or relevance weight information of the plurality of words.

30. An apparatus configured for performing topic-relevance highlighting of electronic text in one or more documents, the apparatus comprising:
at least one processor; and
a memory coupled to the at least one processor,
wherein the at least one processor is configured to:
categorize a plurality of words in the electronic text into one or more classes, wherein each class represents a topic of interest;
determine one or more relevance weights for the plurality of words based on their relevance to the one or more classes; and
color-code the plurality of words according to their one or more relevance weights such that one or more words of the plurality of words categorized into the same class with the same topic of interest are highlighted with the same distinctive color.
